(19) United States
(12) Patent Application Publication
(10) Pub. No.: US 2026/0100239 A1
(43) Pub. Date: Apr. 9, 2026

(54) ALIGNMENT TIP FOR A CHARACTERIZATION DEVICE

(71) Applicant: SYNCHROTRON SOLEIL, Saint-Aubin (FR)

(72) Inventors: Antoine LONCLE, Les Ulis (FR); Robin LENER, Massy (FR); Stefan KUBSKY, Orsay (FR); François NICOLAS, Livre-sur-Changeon (FR)

(21) Appl. No.: 19/113,170

(22) PCT Filed: Oct. 19, 2023
(86) PCT No.: PCT/EP2023/079131

§ 371 Date: Mar. 19, 2025

(30) Foreign Application Priority Data
Oct. 21, 2022 (FR) FR2210926

(51) Int. Cl. G12B 5/00; G01Q 70/10; G01Q 70/14

(52) U.S. Cl. CPC G12B 5/00; G01Q 70/10; G01Q 70/14

(57) ABSTRACT

An alignment tip for a sample characterization device, the alignment tip includes an alignment head that is made of a material having an atomic weight greater than 50 and has an essentially spherical shape, and a body that is connected to the alignment head and is configured to be placed in a sample support.

### TECHNICAL FIELD

The present invention relates to an alignment tip for a sample characterization device.

The field of the invention is, but is not limited to, that of characterizing samples by light, electron or ion radiation.

### PRIOR ART

In order to be able to characterize samples using a beam of radiation from a measuring or characterization device, such as diffractometers, the samples must be aligned with respect to this beam to enable correct analysis of the measurement signals.

Alignment is usually performed using a reference object, such as a test pattern, placed in the measuring beam.

According to one example, crosses made in particular of tungsten wire are used to align samples in lines of light. Alignment is achieved using a goniometer whose axis of rotation is positioned on the axis of the radiation beam, with the axes of the goniometer and the beam not being parallel.

The crosses do not allow sufficient rotation to achieve alignment in the entire angular space, as this alignment is required to be able to perform and correct all the movements necessary for analysis of the samples. Also, as these crosses are two-dimensional structures, a beam of radiation with non-orthogonal incidence produces an apparent thickness greater than the actual thickness.

In another example, Siemens test patterns or stars are used to achieve alignment in lines of light, with a resolution of a few nanometers. However, the cost of such objects is very high.

Typically, the reference objects of the prior art are two-dimensional objects and do not allow alignment along the three axes of rotation in space. Furthermore, they are not suitable for mounting in a measuring device or on a goniometer in the same way as the samples to be characterized. The resulting alignment and measurement corrections are then not sufficiently accurate.

The article by M. Holler et al., “X-ray ptychographic computed tomography at 16 nm isotropic 3D resolution”, Scientific Reports 4, 3857 (2014) describes ptychographic measurements with three-dimensional test objects made of porous silicon dioxide. However, these objects are very fragile and their manufacture cannot be reproduced.

### DISCLOSURE OF THE INVENTION

The aim of the invention is to provide an alignment tip that can be used under conditions identical to those for sample characterization.

Another aim of the present invention is to provide an alignment tip whose manufacturing method is simple to implement, reproducible and inexpensive.

A further aim of the present invention is to provide an alignment tip that can be used in a variety of applications, and notably for the characterization of measuring or characterization devices.

At least one of these aims is achieved with an alignment tip for a sample characterization device, the alignment tip comprising:
an alignment head that is made of a material having an atomic weight greater than 50 and has an essentially spherical shape, and
a body that is connected to the alignment head and is configured to be placed in a sample support.

The alignment tip according to the present invention is intended for use in a characterization or measuring device, for example to measure or characterize samples, or to characterize measuring devices themselves. When used, the alignment tip can be placed in, or connected to, a sample support of the measuring device, in the same way as a sample to be measured.

By virtue of its substantially spherical shape, the head of the alignment tip can be turned in any direction in space.

When a sample to be measured needs to be aligned with respect to a measuring beam, the alignment tip is pre-positioned such that the alignment head is in the axis of the beam. As the head is a three-dimensional structure, difficulties associated with a non-orthogonal incidence of the beam are eliminated. Thus, the accuracy of the positioning of the samples in this device is improved, which improves the operation of the device. The time and therefore the cost of measuring can be optimized.

In this type of measuring device, the measuring beam can be a light beam, an electron beam or an ion beam.

The alignment tip according to the invention has a simple and solid structure which can be easily manufactured and whose dimensions can be selected to be similar or of the same order of magnitude as those of the samples to be measured or of the size of a measuring beam used in a measuring or characterization device.

Also, a single alignment tip according to the invention can be used repeatedly and in different types of measuring device with a suitable sample support into which it can be placed. Thus, the alignment tip can be implemented in numerous applications.

The term “essentially spherical” means that the alignment head does not represent a perfect sphere. The sphere can notably have a non-sphericity of up to around 10%. This means that the minimum radius and the maximum radius of the sphere can differ from each other by up to around 10%. This non-sphericity is due to the nature of the alignment tip manufacturing method. However, the quality of the sphere of the head is sufficient for the applications for which it is intended.

According to one embodiment, the diameter of the head can be between 5 μm and 100 μm.

These dimensions correspond notably to the typical dimensions of samples that can be measured or characterized with devices wherein the alignment tip according to the invention is implemented.

These dimensions also correspond to those of a measuring beam used in measuring devices.

According to an advantageous embodiment, a collar region of the body in the immediate vicinity of the alignment head has a diameter substantially less than the diameter of the head.

The collar region, which forms part of the body of the alignment tip, is located in the immediate vicinity of the sphere of the head. In this collar region, the dimensions of the body are such that the head is securely held by the body, but that they are substantially less than and not comparable to the diameter of the head.

When the alignment tip is implemented in a measuring or characterization device, the alignment, the measurement or the characterization are performed using the substantially spherical head. When the tip is placed in a measuring beam, it is important that the collar region does not interfere with the use of the tip. The diameter of the collar region should therefore be as small as possible. In particular, the collar region must hide the measuring beam as little as possible, notably when the beam is at non-orthogonal incidence, in order to be able to obtain a satisfactory contrast image.

According to embodiments, a diameter of the collar region may be between 2 μm and 80 μm.

Advantageously, a ratio between a length of the tapered part of the body and a diameter of the rod-shaped part of the body is equal to or greater than 0.5.

This minimum ratio has proved advantageous for avoiding disturbances induced by an excessively wide body, for example when a measuring beam is at non-orthogonal incidence, and in particular for obtaining a usable contrast image.

Advantageously, the body can comprise a rod-shaped part and a tapered part, the tapered part being in the vicinity of the alignment head.

The diameter of the body thus increases between the head and the other end of the body.

According to embodiments, a diameter of the body may be between 80 μm and 300 μm.

According to an advantageous embodiment, the head and the body can form a single unit.

The head and the rod of the tip thus constitute a single piece. There are no bonding points or similar that could weaken the junction between the head and the body. The single unit withstands difficult measuring conditions, for example cryogenic conditions.

The material(s) of the tip are selected for their strength, their resistance to radiation but also based on their cost.

Advantageously, the head is made of a material with a high atomic weight (greater than 50). The alignment head can notably be made of tungsten.

In fact, in order to align the alignment tip with respect to a measuring beam, it is important for the head of the tip to produce a shadow when placed in the beam, in order to be able to assess its correct positioning. In the case of electron or X-ray beams, the material used for the alignment head must have a sufficiently high atomic weight so that the beam is partially or completely obscured by the head producing the contrast.

According to one embodiment, the alignment tip according to the invention may comprise a removable base.

The removable base is notably suitable for being placed in a sample support of a measuring or characterization device.

According to a first implementation example, the alignment tip according to the present invention can be used as a two-dimensional or three-dimensional reference object, under projection of a measuring beam, for aligning a sample in a sample characterization device or for characterizing measuring devices as a reference sample.

The alignment tip can notably be used for centering a goniometer, for aligning the alignment tip with respect to a radiation or measuring beam of a sample characterization device.

The alignment tip can then be used as follows:
placing the alignment tip according to the invention in a sample support of the goniometer,
recording position, displacement and dimension parameters of the alignment tip in a control module,
centering the alignment tip with respect to the measuring beam using dimension parameters, and
replacing the alignment tip with a sample to be characterized.

According to a second implementation example, the alignment tip according to the present invention can be used as a three-dimensional reference object.

In fact, the alignment head may feature three-dimensional structures, such as hollow areas or gaps. Three-dimensional structures can notably be found in the volume of the alignment head, but also on the surface thereof. These generally irregular 3D structures are notably resistant to the measuring beams implemented in the devices wherein the alignment tip is to be used.

A micro-structured alignment tip can be used to determine the volume resolution of a measuring or characterization device, and notably in tomography or ptychography.

Durable nanometric structures are typically very difficult to obtain, and their manufacture (by focused ion beam) is very expensive. An alignment tip according to the present invention constitutes a 3D structured object that is highly resistant to difficult implementation conditions, such as high doses of ionizing radiation or cryogenic conditions. They are compatible with permanent use, i.e., with at least a hundred uses.

According to a third implementation example, the alignment tip according to the present invention can be used as a functionalized reference object for fluorescence measurements.

For this purpose, the head of the tip may comprise a fluorescent material. The fluorescent material can notably be introduced into hollow areas present in the alignment head.

The alignment tip thus enables, for example, the parameterization and calibration of the detection in X-ray fluorescence spectrometry, by functioning as a 3D marker.

According to a fourth implementation example, the alignment tip according to the present invention can be used as a refractive optical element.

In fact, the head of the tip can feature curved crystalline zones that can function as focusing lenses for electromagnetic radiation.

### DESCRIPTION OF THE FIGURES AND EMBODIMENTS

Other benefits and features shall become evident upon examining the detailed description of entirely non-limiting examples, and from the appended drawings in which:

FIG. 1 is a schematic representation of an alignment tip according to one embodiment of the invention, inserted in a support;

FIG. 2 is an optical microscope image of a detail of an alignment tip according to one embodiment of the invention; and

FIG. 3 shows an image produced with an alignment tip according to the invention inserted in a hard X-ray beam.

It is clearly understood that the embodiments that will be described hereafter are by no means limiting. In particular, all of the described variants and embodiments can be combined with each other if there is no technical obstacle to this combination.

In the figures, the same reference may be used for the features that are common to several figures.

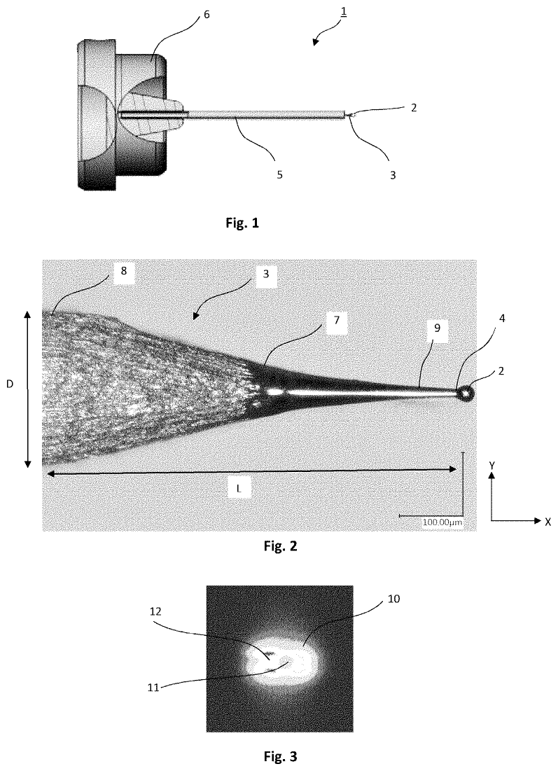

Embodiments of an alignment tip according to the invention will be described with reference to FIGS. 1 and 2.

The tip 1, as shown in FIG. 1, comprises an alignment head 2 and a body 3 connected to the head 2.

The head 2 is essentially spherical in shape. An image of an example embodiment is shown in FIG. 2. An alignment head 2 and a part of the body 3 connected to the head 2 are shown, observed with an optical microscope. In this example, the head 2 and the body 3 are formed of a single piece.

The junction 4 between the head 2 and the body 3 has a diameter, or a transverse dimension when the cross-section of the junction is not round, much less than the diameter of the head 2. The diameter of the head is between 5 μm and 100 μm. The diameter, or the transverse dimension, of junction 4 between the head and the body 3 is preferably between 2 μm and 80 μm.

By way of example, with reference to FIG. 2, the diameter of the head is about 30 μm, and the diameter of junction 4 in the immediate vicinity of the head is about 10 μm.

The body 3 of the tip 1 comprises a rod-shaped part 8 and a conical or tapered part 7. The conical part 7 corresponds to a thinned region of the body 3. In the embodiment shown in FIG. 2, however, the generatrix of the envelope of the “cone” is not straight, but describes approximately a circular line.

By way of example, the length of thinned region 7 can be between 100 μm and 1 mm.

Of course, the thinned region of the body can also have other shapes. It can notably be shaped like a real cone or a rod.

The alignment tip 1 can be positioned in a sample support of a measuring or characterization device. In the embodiment as shown in FIG. 1, the sample support consists of a base 6 and a cannula 5. The cannula 5 accommodates the body 3 of the alignment tip, the internal diameter of cannula 5 being substantially the same as the external diameter of the end of the body 3. The cannula 5 can be seen as a removable base for the tip 1. The base 6 is suitable for installation in a standardized measuring or characterization device.

Thus, when such an alignment tip is inserted into the measuring beam of a measuring device, with the alignment head centered on the center of the beam, an image as shown in FIG. 3 is observed. Herein, the measuring beam is a hard X-ray beam. To produce the image shown in FIG. 3, the alignment tip is oriented horizontally, along the X axis, with the head pointing to the right of the plane of the figure. The head and the body in the collar region partially obscure the beam, thus producing a so-called “corona” effect, i.e., a contrast image caused by partial occultation of the beam. A toroidal-shaped spot 10 is produced in the viewing plane, with a circular shadow 11 in the center and a slit-shaped shadow 12 on the left side of spot 10. These shadows correspond to the location of the head and the body, respectively, of the tip in the path of the beam.

Ideally, the contrast image as observed should have the shape of a perfect “donut”, without the slit at the side. In this case, the alignment or the centering of a sample in the measuring beam can be carried out more efficiently. It is therefore very important that the transverse dimension of the collar region of the body, near the head of the alignment tip, is as small as possible, in order to hide the measuring beam as little as possible.

The alignment tip according to the present invention can be manufactured according to an electrochemical manufacturing method, the steps of which will be detailed below. By way of example, the manufacture of a tungsten alignment tip is presented.

Tungsten rods can be obtained from a simple tungsten wire. The wire can have a diameter of about 250 μm. Part of a rod is subjected to a chemical attack in a sodium hydroxide bath via electrolysis. The immersed part of the rod is then thinned and finally cut by the chemical reaction at the thinnest point. Electrolysis is immediately stopped to keep the thinnest part of the immersed part of the rod. The rod is removed from the sodium hydroxide and immersed in an acid bath of the same concentration as the sodium hydroxide bath in order to stop any chemical reaction on the rod. The rod will thus have a pointed end with dimensions of the order of a few tens of nanometers.

At this stage, the pointed end of the rod can be checked using suitable means, in order to validate the previous manufacturing steps. To do this, an optical microscope, a scanning electron microscope or X-rays can be used.

Next, the pointed end of the rod is subjected to pulsed laser irradiation. To achieve this, the tip is centered on the axis of a beam of a pulsed laser. Between each pulse, the pointed end is progressively inserted into the laser beam, until a physical modification of the tip is obtained. The pointed end undergoes partial local melting, and takes on the spherical shape. The size of the sphere obtained depends on the length of the rod irradiated by the laser.

As can be seen from FIG. 2, the thinned region 7 of the rod 3 between the sphere 2 and the non-immersed part of the rod 3 is approximately conical in shape. However, the generatrix of the envelope of the “cone” is not straight in the example shown, but describes approximately a circular line.

The sphere 2 obtained by irradiation with the laser can also be characterized using an optical microscope, a scanning electron microscope or X-rays. The diameter of the sphere 2 and the dimensions of the rod 3 supporting it can thus be measured. The dimensions of the rod 3 include diameter D at the base of the rod and the diameter of junction 4, the length L of the approximately tapered part and the radius corresponding to the circular line of the thinned region 7 of the rod 3. An example of a spherical head 2 and a tungsten rod part 3 is shown in FIG. 2.

By way of example, the sodium hydroxide bath (electrolyte) used for the first dipping of the rod is a 2M NaOH bath, used with a stainless steel electrode. Electrolysis is carried out with a voltage of about 12 V and an electric current that can vary between 10 μA and 1 A, for example 50 mA.

The laser used can be, for example, a Nd:YAG laser delivering pulses with an energy of 10 mJ to 20 J, and notably 1 ms pulses with an energy of 1.5 J.

The rod and the sphere at its end then constitute the body and the head of an alignment tip according to the invention. The tip can then be inserted into a suitable support for use in a measuring or characterization device.

Examples of implementation of the alignment tip according to the present invention will be described later.

According to a first implementation example, the alignment tip according to the present invention can be used as a two-dimensional or three-dimensional reference object, under projection of a measuring beam in a sample characterization device.

The tip can notably be used to align a sample with respect to this measuring beam.

This alignment can for example be carried out using a goniometer, wherein the alignment tip is positioned using a sample support, as shown in FIG. 1. Ideally, this is the same sample support that will be used for the sample(s) to be measured later. The position of the alignment tip is then adjusted with respect to the measuring beam using the goniometer. An image as shown in FIG. 3 can then be observed. Parameters relating to the position, the displacement (for example rotation) and the dimensions of the tip are stored in a reference table. The alignment tip is then removed from the sample support, and a sample to be measured is placed in the same support to be measured.

An alignment tip according to the invention can also be used to test and characterize measuring devices. In this case, the alignment tip is used as a reference sample for the successive improvement of devices such as light lines and off-synchrotron x-ray microscopy stations. It is then possible to compare measurements from these different devices.

According to a second implementation example, the alignment tip according to the invention can be used as a three-dimensional reference object.

In fact, depending on the material used and the manufacturing method of the tip, the alignment head may present three-dimensional structures, such as hollow zones or gaps, which can notably be found in the volume of the alignment head, but also on its surface. The 3D structures, which may be irregular, cannot be modified and are resistant to the measuring beams (electrons, ions, X-rays) implemented in the devices wherein the alignment tip is to be used. The structures are typically a few tens of nanometers in size.

An alignment tip structured in this way can also be used to test and characterize measuring devices. For example, the volume resolution or the contrast of measuring or characterization devices can be determined. In this case, the alignment tip is used as a reference sample for the successive improvement of devices such as tomography or ptychography devices.

According to a third implementation example, the alignment tip according to the invention can be used as a functionalized reference object for fluorescence measurements.

In fact, it is possible to introduce a fluorescent material into the alignment head, for example into the aforementioned hollow zones present in the alignment head.

Several techniques can be implemented to fill the hollow zones with fluorescent material:
1. The alignment head can be soaked in a solution containing nanobeads and/or fluorescent molecules prior to the formation of the sphere by laser irradiation. During partial melting, the fluorescent substances are at least partially integrated into the volume of the sphere.
2. It is also possible to dip the sphere formed in a solution containing fluorescent nanobeads and/or molecules.

These two techniques can of course be combined. Furthermore, an additional galvanic electromotive force can be applied between the tip and a solution containing fluorescent nanobeads or molecules to improve the integration of fluorescent agents.

Such an alignment tip thus enables, for example, the parameterization and calibration of the detection in X-ray fluorescence spectrometry.

In fact, the sphere can be subjected to a focused ion beam (FIB) to cut a part of the sphere and thus access one or more of the cavities filled with fluorescent material. With this fluorescent cavity, a fluorescence-inducing measuring beam can be scanned to measure the diameter thereof.

According to a fourth implementation example, the alignment tip according to the present invention can be used as a refractive optical element.

In fact, the head of the alignment tip can feature, or be modified to release, one or more crystalline zones existing on the surface thereof. It is also possible to modify the head to uncover or release such crystalline zones. These zones result from the manufacture of the tip, and notably from subjecting the tip to pulsed laser irradiation. The crystalline zones are generally curved and can thus be used as focusing lenses for electromagnetic radiation. For example, such a tip can be used to characterize microlenses for X-rays.

Of course, the invention is not limited to the examples just described, and many adjustments can be made to these examples without going beyond the scope of the invention.

1. An alignment tip to be aligned with respect to a measuring beam in a sample characterization device, the alignment tip comprising:
an alignment head that is made of a material having an atomic weight greater than 50 and has an essentially spherical shape; and
a body that is connected to the alignment head, and is configured to be placed in a sample support.

2. The alignment tip according to claim 1, characterized in that a collar region of the body in the immediate vicinity of the alignment head has a diameter substantially less than the diameter of the head.

3. The alignment tip according to claim 1, characterized in that the body comprises a rod-shaped part and a tapered part, the tapered part being in the vicinity of the alignment head.

4. The alignment tip according to claim 1, characterized in that the head has a diameter of between 5 μm and 100 μm.

5. The alignment tip according to claim 3, characterized in that a ratio between a length of the tapered part of the body and a diameter of the rod-shaped part of the body is greater than or equal to 0.5.

6. The alignment tip according to claim 1, characterized in that the head is made of tungsten.

7. The alignment tip according to claim 1, characterized in that the head and the body form a single piece.

8. A use of the alignment tip according to claim 1 as a two-dimensional or three-dimensional reference object in a sample characterization device.

9. A use of the alignment tip according to claim 1 as a three-dimensional reference object in a sample characterization device, the alignment head comprising microstructures.

10. A use of the alignment tip according to claim 1 as a functionalized reference object in a sample characterization device by fluorescence, the alignment head comprising a fluorescent material.

11. A use of the alignment tip according to claim 1 as a refractive optical element, the alignment head comprising at least one refractive crystalline zone.
